(19) United States
(12) Patent Application Publication
(10) Pub. No.: US 2019/0306089 A1
(43) Pub. Date: Oct. 3, 2019

(54) APPARATUS, METHOD, AND PROGRAM PRODUCT FOR INCLUDING INPUT TECHNIQUE INFORMATION WITH TEXTUAL MESSAGES

(71) Applicant: LENOVO (Singapore) PTE. LTD., New Tech Park (SG)

(72) Inventors: Russell Speight VanBlon, Raleigh, NC (US); Nathan J. Peterson, Oxford, NC (US); John Carl Mese, Cary, NC (US)

(21) Appl. No.: 15/937,337

(22) Filed: Mar. 27, 2018

(51) Int. Cl. H04L 12/58; G06F 3/01

(52) U.S. Cl. CPC H04L 51/04; H04L 51/06; G06F 3/013

(57) ABSTRACT

Apparatuses, methods, and program products are disclosed for including input technique information with textual messages. One apparatus includes a processor and a memory that stores code executable by the processor. The code is executable by the processor to detect, by use of the processor, an input technique used to produce a textual message. The code is executable by the processor to transmit information corresponding to the input technique together with the textual message to provide a reader of the textual message the information corresponding to the input technique used to produce the textual message.

### FIELD

The subject matter disclosed herein relates to textual messages and more particularly relates to including input technique information with textual messages.

### BACKGROUND

### Description of the Related Art

Information handling devices, such as desktop computers, laptop computers, tablet computers, smart phones, optical head-mounted display units, smart watches, televisions, streaming devices, etc., are ubiquitous in society. These information handling devices may be used for performing various actions. Performing various actions, such as displaying textual messages, may not provide a user with information about how the textual message was produced.

### BRIEF SUMMARY

An apparatus for including input technique information with textual messages is disclosed. A method and computer program product also perform the functions of the apparatus. In one embodiment, the apparatus includes a processor and a memory that stores code executable by the processor. The code, in various embodiments, is executable by the processor to detect, by use of the processor, an input technique used to produce a textual message. The code, in certain embodiments, is executable by the processor to transmit information corresponding to the input technique together with the textual message to provide a reader of the textual message the information corresponding to the input technique used to produce the textual message.

In some embodiments, the code executable by the processor detects the input technique used to produce the textual message by detecting that the input technique is one or more of a voice, a keyboard, and a touch screen. In one embodiment, the code executable by the processor stores the information corresponding to the input technique with the textual message by storing metadata including the information corresponding to the input technique.

In various embodiments, the code executable by the processor transmits information corresponding to producing the textual message with the textual message. In some embodiments, the code executable by the processor transmits the information corresponding to producing the textual message with the textual message by transmitting an indication indicating one or more of that the textual message was produced without proofreading the textual message, without reading the textual message, while walking, while driving, without editing the textual message, while multitasking, and with a word confidence selection.

A method for including input technique information with textual messages, in one embodiment, includes detecting, by use of a processor, an input technique used to produce a textual message. In certain embodiments, the method includes transmitting information corresponding to the input technique together with the textual message to provide a reader of the textual message the information corresponding to the input technique used to produce the textual message.

In some embodiments, detecting the input technique used to produce the textual message includes detecting that the input technique is one or more of a voice, a keyboard, and a touch screen. In various embodiments, the method includes storing the information corresponding to the input technique with the textual message, wherein storing the information includes storing metadata having the information corresponding to the input technique. In one embodiment, the method includes storing the information corresponding to the input technique with the textual message, wherein storing the information includes storing an indication indicating that the input technique is one or more of a voice, a keyboard, and a touch screen.

In some embodiments, the method includes transmitting information corresponding to producing the textual message with the textual message. In certain embodiments, transmitting the information corresponding to producing the textual message with the textual message includes transmitting an indication indicating one or more of that the textual message was produced without proofreading the textual message, without reading the textual message, while walking, while driving, without editing the textual message, while multitasking, and with a word confidence selection.

In some embodiments, the method includes transmitting word confidence choices with the indication indicating that the textual message was produced with the word confidence selection. In various embodiments, the method includes detecting whether the textual message is read before the textual message is transmitted, and transmitting the indication indicating that the textual message was produced without reading the textual message in response to detecting that the textual message is not read before the textual message is transmitted. In certain embodiments, detecting whether the textual message is read before the textual message is transmitted includes using eye tracking to detect whether the textual message is read.

In one embodiment, a program product includes a computer readable storage input technique that stores code executable by a processor. The executable code, in certain embodiments, includes code to perform detecting, by use of the processor, an input technique used to produce a textual message. The executable code, in various embodiments, includes code to perform transmitting information corresponding to the input technique together with the textual message to provide a reader of the textual message the information corresponding to the input technique used to produce the textual message.

In certain embodiments, the executable code further includes code to perform detecting that the input technique is one or more of a voice, a keyboard, and a touch screen. In various embodiments, the executable code further includes code to perform storing metadata having the information corresponding to the input technique.

In one embodiment, the executable code further includes code to perform transmitting an indication indicating that the input technique is one or more of a voice, a keyboard, and a touch screen. In certain embodiments, the executable code further includes code to perform transmitting an indication indicating one or more of that the textual message was produced without proofreading the textual message, without reading the textual message, while walking, while driving, without editing the textual message, while multitasking, and with a word confidence selection. In various embodiments, the executable code further includes code to perform transmitting word confidence choices with the indication indicating that the textual message was produced with the word confidence selection.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a system for including input technique information with textual messages;

FIG. 2 is a schematic block diagram illustrating one embodiment of an apparatus including an information handling device;

FIG. 3 is a schematic block diagram illustrating one embodiment of an apparatus including a message module;

FIG. 4 is a schematic block diagram illustrating another embodiment of an apparatus including a message module;

FIG. 5 is a schematic flow chart diagram illustrating an embodiment of a method for including input technique information with textual messages; and

FIG. 6 is a schematic flow chart diagram illustrating another embodiment of a method for including input technique information with textual messages.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification have been labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. These code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

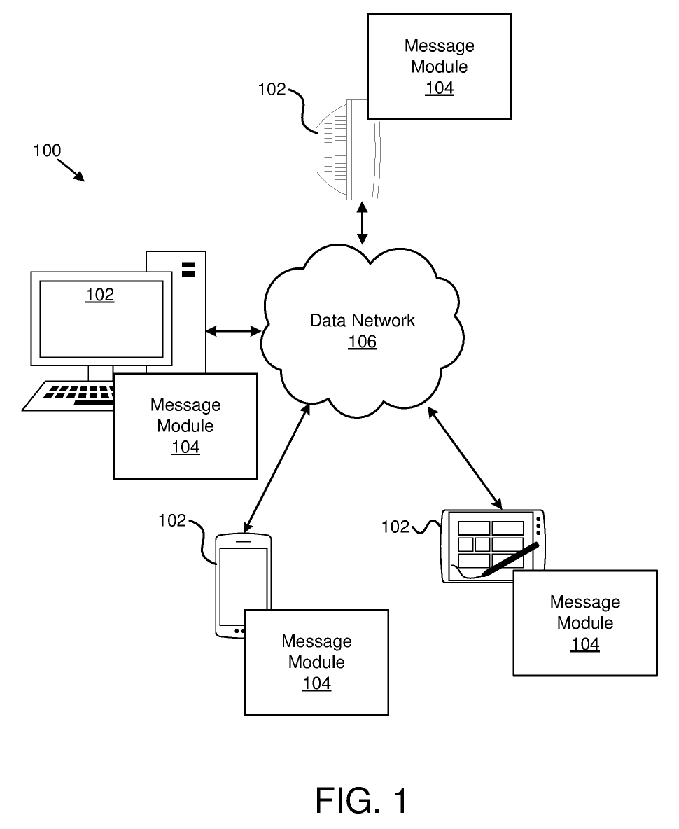

FIG. 1 depicts one embodiment of a system 100 for including input technique information with textual messages. In one embodiment, the system 100 includes information handling devices 102, message modules 104, and data networks 106. Even though a specific number of information handling devices 102, message modules 104, and data networks 106 are depicted in FIG. 1, one of skill in the art will recognize that any number of information handling devices 102, message modules 104, and data networks 106 may be included in the system 100.

In one embodiment, the information handling devices 102 include computing devices, such as desktop computers, laptop computers, personal digital assistants (PDAs), tablet computers, smart phones, smart televisions (e.g., televisions connected to the Internet), set-top boxes, game consoles, security systems (including security cameras), vehicle on-board computers, network devices (e.g., routers, switches, modems), streaming devices, or the like. In some embodiments, the information handling devices 102 include wearable devices, such as smart watches, fitness bands, optical head-mounted displays, or the like. The information handling devices 102 may access the data network 106 directly using a network connection.

The information handling devices 102 may include an embodiment of the message module 104. In certain embodiments, the message module 104 may detect, by use of a processor, an input technique used to produce a textual message. The message module 104 may also store information corresponding to the input technique with the textual message without including the information corresponding to the input technique in the textual message so that the information corresponding to the input technique is not visible in the textual message to a creator of the textual message. The message module 104 may transmit the information corresponding to the input technique together with the textual message to provide a reader of the textual message the information corresponding to the input technique used to produce the textual message. In this manner, the message module 104 may be used for including input technique information with textual messages.

The data network 106, in one embodiment, includes a digital communication network that transmits digital communications. The data network 106 may include a wireless network, such as a wireless cellular network, a local wireless network, such as a Wi-Fi network, a Bluetooth® network, a near-field communication (“NFC”) network, an ad hoc network, and/or the like. The data network 106 may include a WAN, a storage area network (“SAN”), a LAN, an optical fiber network, the internet, or other digital communication network. The data network 106 may include two or more networks. The data network 106 may include one or more servers, routers, switches, and/or other networking equipment. The data network 106 may also include computer readable storage media, such as a hard disk drive, an optical drive, non-volatile memory, RAM, or the like.

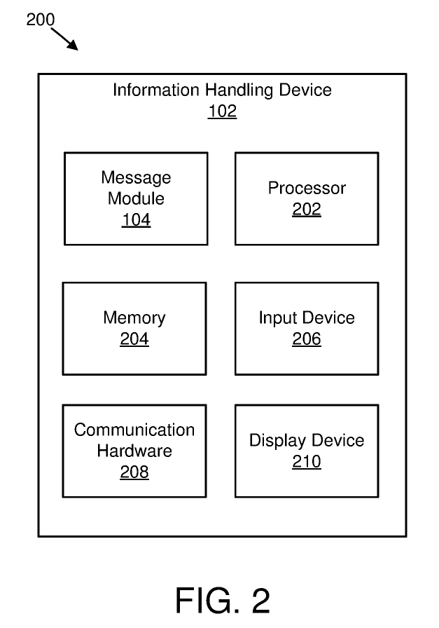

FIG. 2 depicts one embodiment of an apparatus 200 that may be used for including input technique information with textual messages. The apparatus 200 includes one embodiment of the information handling device 102. Furthermore, the information handling device 102 may include the message module 104, a processor 202, a memory 204, an input device 206, communication hardware 208, and a display device 210. In some embodiments, the input device 206 and the display device 210 are combined into a single device, such as a touchscreen.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the message module 104, the input device 206, the communication hardware 208, and the display device 210.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media.

In some embodiments, the memory 204 stores data relating to textual messages. In some embodiments, the memory 204 also stores program code and related data, such as an operating system or other controller algorithms operating on the information handling device 102.

The information handling device 102 may use the message module 104 for including input technique information with textual messages. As may be appreciated, the message module 104 may include computer hardware, computer software, or a combination of both computer hardware and computer software. For example, the message module 104 may include circuitry, or a processor, used to detect, by use of the processor 202, an input technique used to produce a textual message. As another example, the message module 104 may include computer program code that stores information corresponding to the input technique with the textual message without including the information corresponding to the input technique in the textual message so that the information corresponding to the input technique is not visible in the textual message to a creator of the textual message. As a further example, the message module 104 may include computer program code that transmits the information corresponding to the input technique together with the textual message to provide a reader of the textual message the information corresponding to the input technique used to produce the textual message.

The input device 206, in one embodiment, may include any known computer input device including a touch panel, a button, a keyboard, a stylus, or the like. In some embodiments, the input device 206 may be integrated with the display device 210, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel. The communication hardware 208 may facilitate communication with other devices. For example, the communication hardware 208 may enable communication via Bluetooth®, Wi-Fi, and so forth.

The display device 210, in one embodiment, may include any known electronically controllable display or display device. The display device 210 may be designed to output visual, audible, and/or haptic signals. In some embodiments, the display device 210 includes an electronic display capable of outputting visual data to a user. For example, the display device 210 may include, but is not limited to, an LCD display, an LED display, an OLED display, a projector, or similar display device capable of outputting images, text, or the like to a user. As another, non-limiting, example, the display device 210 may include a wearable display such as a smart watch, smart glasses, a heads-up display, or the like. Further, the display device 210 may be a component of a smart phone, a personal digital assistant, a television, a table computer, a notebook (laptop) computer, a personal computer, a vehicle dashboard, a streaming device, or the like.

In certain embodiments, the display device 210 includes one or more speakers for producing sound. For example, the display device 210 may produce an audible alert or notification (e.g., a beep or chime). In some embodiments, the display device 210 includes one or more haptic devices for producing vibrations, motion, or other haptic feedback. For example, the display device 210 may produce haptic feedback upon performing an action.

In some embodiments, all or portions of the display device 210 may be integrated with the input device 206. For example, the input device 206 and display device 210 may form a touchscreen or similar touch-sensitive display. In other embodiments, the display device 210 may be located near the input device 206. In certain embodiments, the display device 210 may receive instructions and/or data for output from the processor 202 and/or the message module 104.

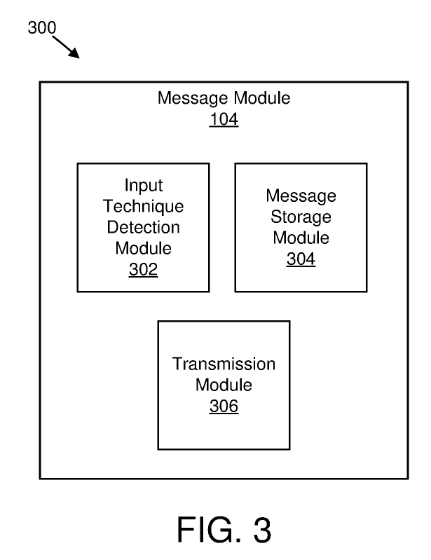

FIG. 3 depicts a schematic block diagram illustrating one embodiment of an apparatus 300 that includes one embodiment of the message module 104. Furthermore, the message module 104 includes an input technique detection module 302, a message storage module 304, and a transmission module 306.

In certain embodiments, the input technique detection module 302 may detect (e.g., by use of a processor) an input technique used to produce a textual message. The input technique used to produce a textual message may be any suitable type of input technique, such as a voice input technique, a keyboard input technique, a touch screen input technique, and/or any other type of input technique that can be used to produce a textual message. By detecting the input technique used to produce the textual message, the input technique may be provided to a reader of the textual message to help the reader better understand the textual message. For example, in embodiments in which the input technique is a voice input technique that is converted to the textual message via a voice-to-text conversion, the textual message may have incorrect words that were incorrectly converted from voice to text. A reader (e.g., viewer, recipient, etc.) of the textual message may not understand the textual message because of the incorrect words. Thus, the input technique used to produce the textual message may be provided to the reader to provide some additional information about the textual message to the reader.

As described herein, the input technique may be provided to the reader as a direct result (e.g., automatically, by computer software, without human intervention) of the creator of the textual message using the input technique and without the creator adding the input technique information to the textual message at a time in which a textual message is created. As may be appreciated, the creator of the textual message may be able to set settings used to customize what types of input technique information are included with textual messages and/or what recipients are able to obtain the types of input technique information.

In one embodiment, the message storage module 304 may store information corresponding to the input technique with the textual message without including the information corresponding to the input technique in the textual message so that the information corresponding to the input technique is not visible in the textual message to a creator of the textual message. In certain embodiments, as the creator of the textual message produces the textual message, the information corresponding to the input technique is not shown to the creator as part of the textual message (e.g., in the body of the textual message). In other embodiments, as the creator of the textual message produces the textual message, the information corresponding to the input technique may be shown to the creator as part of the textual message (e.g., in the body of the textual message). In some embodiments, the information corresponding to the input technique is stored as metadata that is associated with the textual message. In various embodiments, information stored with the textual message may include an indication indicating that the input technique used to produce the textual message is a voice, a keyboard, and/or a touch screen.

In some embodiments, the message storage module 304 may store information corresponding to producing the textual message with the textual message. For example, the message storage module 304 may store an indication indicating that the textual message was produced: without proofreading (e.g., editing, changing) the textual message; without reading the textual message; while walking; while driving; without editing the textual message; while multitasking; and/or with a word confidence selection. In such embodiments, a software application producing the textual message may detect information about how the textual message was produced.

For example, the software application may detect and/or track whether any changes are made to the textual message after it is originally created in order to determine that the textual message was produced without proofreading the textual message and/or without editing the textual message. As another example, the software application may detect and/or track whether a user reads the textual message after it is originally created (e.g., using eye tracking software and/or another suitable method) in order to determine that the textual message was produced without reading the textual message. As a further example, the software application may detect and/or track (e.g., using GPS or another means) whether a person is moving at a walking and/or driving speed to determine whether the user produced the textual message while walking and/or driving. As an additional example, the software application may detect and/or track a number of different software applications that a user switches between while producing the textual message to determine whether the user is multitasking while creating the textual message.

A word confidence selection and/or word confidence choice may refer to a user and/or a software application selecting a word based on a confidence that the word is the correct word for a context. For example, while and/or after a user creates a textual message, word choices may be provided to a user and/or a software application for selecting the best word for a given context. The user and/or the software application may attempt to select the best word for the given context. At certain times, the selected word may have been selected in error thereby making the textual message unclear. In such embodiments, different words for which a word confidence selection and/or a word confidence choice that was made may be stored with the textual message to be provided with the textual message and/or an indication that a word confidence selection and/or choice was made may be stored with the textual message to be provided with the textual message.

As may be appreciated, information corresponding to a textual message may include one or more combinations of information described herein. For example, the information may indicate that a user created a textual message on a touch screen while walking, that a user created a textual message using voice input while driving, and/or that a user created a textual message using a keyboard while multitasking.

In various embodiments, the transmission module 306 may transmit the information corresponding to the input technique together with the textual message to provide a reader of the textual message the information corresponding to the input technique used to produce the textual message. In certain embodiments, the transmission module 306 may transmit any saved information corresponding to the textual message with the textual message to aid the reader in understanding the textual message. In some embodiments, the transmission module 306 may transmit information corresponding to producing the textual message with the textual message. For example, the transmission module 306 may transmit an indication indicating one or more of that the textual message was produced without proofreading the textual message, without reading the textual message, while walking, while driving, without editing the textual message, while multitasking, and with a word confidence selection. In various embodiments, the transmission module 306 may transmit word confidence choices with an indication indicating that the textual message was produced with the word confidence selection. In certain embodiments, the transmission module 306 may transmit an indication indicating that the textual message was produced without reading the textual message in response to detecting that the textual message is not read before the textual message is transmitted.

In some embodiments, information about the textual message is inserted and/or appended to the textual message prior to the textual message being transmitted. In various embodiments, information about the textual message is transmitted separate from a body portion of the textual message. In such embodiments, the information about the textual message may be added to the body portion of textual message by a software application of the reader and/or displayed adjacent to the body portion of the textual message by the software application of the reader.

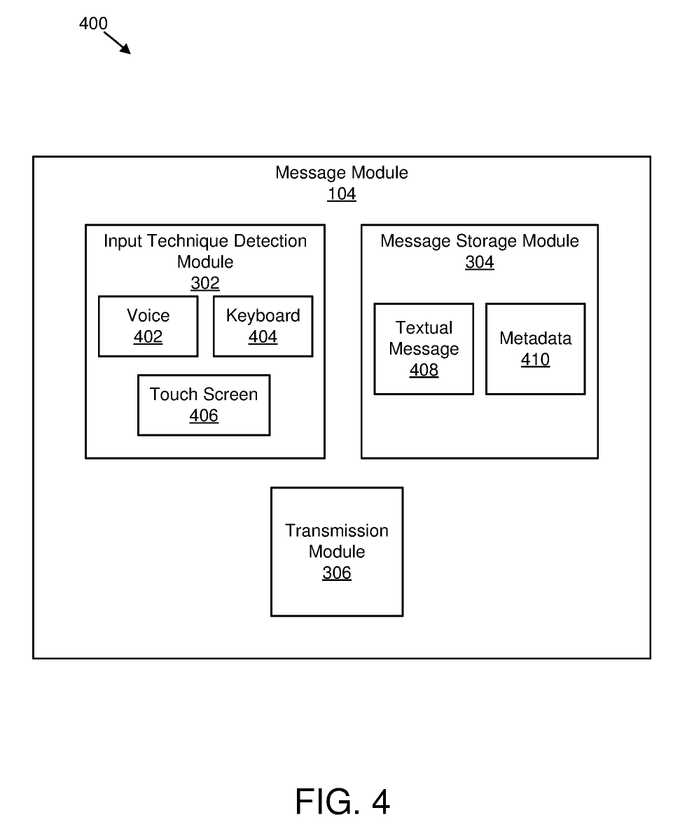

FIG. 4 is a schematic block diagram illustrating another embodiment of an apparatus 400 that includes one embodiment of the message module 104. Furthermore, the message module 104 includes one embodiment of the input technique detection module 302, the message storage module 304, and the transmission module 306, that may be substantially similar to the input technique detection module 302, the message storage module 304, and the transmission module 306 described in relation to FIG. 3. The input technique detection module 302 includes input techniques that may include a voice 402, a keyboard 404, and/or a touch screen 406. The message storage module 304 may include a textual message 408 and/or metadata 410.

The voice 402 input technique may be any suitable voice input technique that may be received as an audible input and converted to a textual message. For example, the voice 402 input technique may be a spoken voice of a person, an electronically produced voice, a replay of a recording, a noise, or so forth.

The keyboard 404 input technique may be any suitable input technique that may receive an input that is used to produce a textual message. For example, the keyboard 404 input technique may be a standard physical computer keyboard (e.g., QWERTY keyboard with physical keys), a touch screen keyboard, a projected keyboard, an image of a keyboard, and/or another input device that can receive input used to produce a textual message.

The touch screen 406 input technique may be any suitable touch screen input technique that may receive a touch input that can be used to produce a textual message. For example, the touch screen 406 input technique may be a touch screen keyboard, a touch screen drawing pad, and/or another touch screen input that can receive a touch input used to produce a textual message.

The textual message 408 may be any type of textual message. For example, the textual message 408 may be an email message, a text message, an instant message, a blog message, an electronic post, and/or another message that includes text.

The metadata 410 may be any type of data that describes and/or gives information about the textual message 408. For example, the metadata 410 may include: information corresponding to an input technique used to produce the textual message 408; an indication indicating the input technique used to produce the textual message 408; information corresponding to producing the textual message 408 (e.g., indication indicating that the textual message 408 was produced: without proofreading the textual message 408, without reading the textual message 408, while walking, while driving, without editing the textual message 408, while multitasking, and/or with a word confidence selection); information indicating that the textual message 408 was produced with a word confidence selection; information indicating that the textual message 408 was produced without reading the textual message in response to detecting that the textual message is not read before the textual message is transmitted; and/or any other suitable types of information. In some embodiments, the metadata 410 is stored with the textual message 408 and/or transmitted with the textual message 408. In such embodiments, the metadata 410 may not be visible to a creator of the textual message 408, but may be used to show information about the textual message 408 to a reader of the textual message 408. For example, in one embodiment, the metadata 410 may not be visible to a creator of the textual message 408, but the metadata 410 may be inserted into the textual message 408 so that the textual message 408 includes the metadata 410 in the body of the textual message 408 upon transmission of the textual message 408. As another example, the metadata 410 may be transmitted with the body of the textual message 408, and an application of a reader of the textual message 408 may make the metadata 410 visible to the reader of the textual message 408 (e.g., either by inserting the metadata 410 into the body of the textual message 408, or by showing the metadata 410 in another manner—such as by showing the metadata 410 adjacent to the textual message 408). In other embodiments, the metadata 410 may be visible to the creator of the textual message 408 and/or the reader of the textual message 408. In such embodiments, the metadata 410 may be visible separate from the textual message 408. For example, the metadata 410 may not be part of the textual message 408 (e.g., in the body of an email message), but the metadata 410 may be displayed to a viewer of the email message as additional information to the textual message 408.

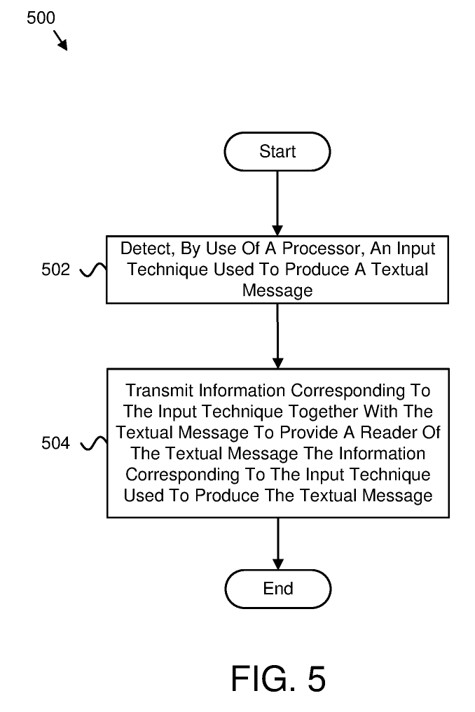

FIG. 5 is a schematic flow chart diagram illustrating an embodiment of a method 500 for including input technique information with textual messages. In some embodiments, the method 500 is performed by an apparatus, such as the information handling device 102. In other embodiments, the method 500 may be performed by a module, such as the message module 104. In certain embodiments, the method 500 may be performed by a processor executing program code, for example, a microcontroller, a microprocessor, a CPU, a GPU, an auxiliary processing unit, a FPGA, or the like.

The method 500 may include detecting 502, by use of a processor (e.g., the processor 202), an input technique used to produce a textual message. In certain embodiments, the input technique detection module 302 may detect 502 the input technique used to produce the textual message. In some embodiments, detecting 502 the input technique used to produce the textual message includes detecting that the input technique is a voice, a keyboard, and/or a touch screen.

The method 500 may include transmitting 504 information corresponding to the input technique together with the textual message to provide a reader of the textual message the information corresponding to the input technique used to produce the textual message, and the method 500 may end. In some embodiments, the transmission module 306 may transmit 504 the information corresponding to the input technique together with the textual message.

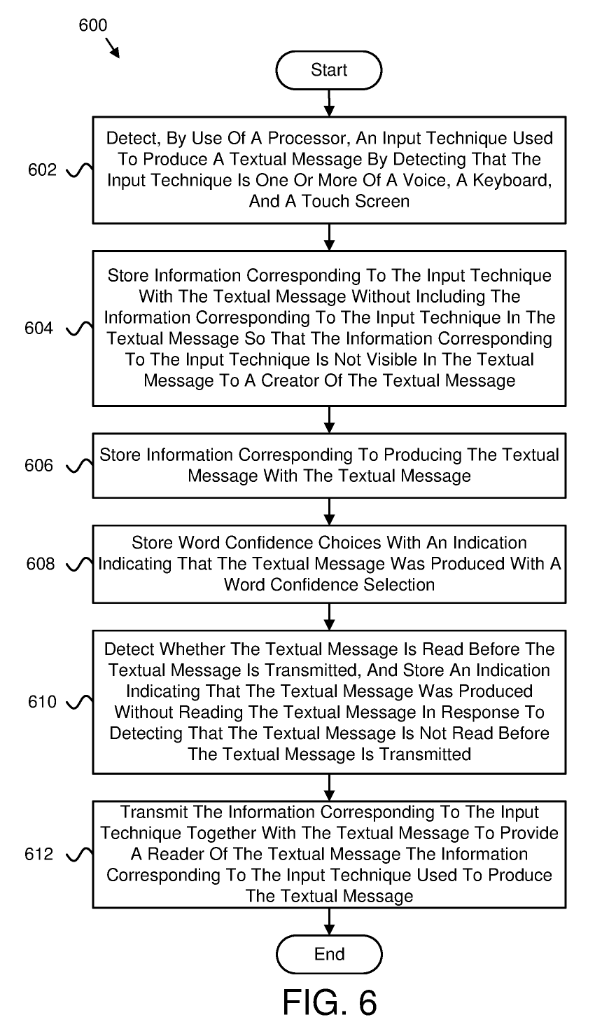

FIG. 6 is a schematic flow chart diagram illustrating another embodiment of a method 600 for including input technique information with textual messages. In some embodiments, the method 600 is performed by an apparatus, such as the information handling device 102. In other embodiments, the method 600 may be performed by a module, such as the message module 104. In certain embodiments, the method 600 may be performed by a processor executing program code, for example, a microcontroller, a microprocessor, a CPU, a GPU, an auxiliary processing unit, a FPGA, or the like.

The method 600 may include detecting 602, by use of a processor (e.g., the processor 202), an input technique used to produce a textual message. In certain embodiments, the input technique detection module 302 may detect 602 the input technique used to produce the textual message. In some embodiments, detecting 602 the input technique used to produce the textual message includes detecting that the input technique is a voice, a keyboard, and/or a touch screen.

The method 600 may also include storing 604 information corresponding to the input technique with the textual message without including the information corresponding to the input technique in the textual message so that the information corresponding to the input technique is not visible in the textual message to a creator of the textual message. In certain embodiments, the message storage module 304 may store 604 the information corresponding to the input technique with the textual message without including the information corresponding to the input technique in the textual message. In various embodiments, storing 604 the information corresponding to the input technique with the textual message includes storing metadata having the information corresponding to the input technique. In various embodiments, storing 604 the information corresponding to the input technique with the textual message includes storing an indication indicating that the input technique is a voice, a keyboard, and/or a touch screen. In some embodiments, the information corresponding to the input technique may not be stored. Moreover, in certain embodiments, the information corresponding to the input technique may be stored so that the information corresponding to the input technique is visible in the textual message to a creator of the textual message.

The method 600 may include storing 606 and/or transmitting information corresponding to producing the textual message with the textual message. In certain embodiments, the message storage module 304 may store 606 the information corresponding to producing the textual message with the textual message. In some embodiments, storing 606 the information corresponding to producing the textual message with the textual message includes storing an indication indicating that the textual message was produced: without proofreading the textual message, without reading the textual message, while walking, while driving, without editing the textual message, while multitasking, and/or with a word confidence selection.

The method 600 may include storing 608 and/or transmitting word confidence choices with an indication indicating that the textual message was produced with a word confidence selection. In certain embodiments, the message storage module 304 may store 608 the word confidence choices with the indication indicating that the textual message was produced with the word confidence selection.

The method 600 may include detecting 610 whether the textual message is read before the textual message is transmitted, and storing and/or transmitting the indication indicating that the textual message was produced without reading the textual message in response to detecting that the textual message is not read before the textual message is transmitted. In certain embodiments, the message storage module 304 may detect 610 whether the textual message is read before the textual message is transmitted, and store the indication indicating that the textual message was produced without reading the textual message in response to detecting that the textual message is not read before the textual message is transmitted. In various embodiments, detecting 610 whether the textual message is read before the textual message is transmitted includes using eye tracking to detect whether the textual message is read.

The method 600 may include transmitting 612 the information corresponding to the input technique together with the textual message to provide a reader of the textual message the information corresponding to the input technique used to produce the textual message, and the method 600 may end. In some embodiments, the transmission module 306 may transmit 612 the information corresponding to the input technique together with the textual message.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
a processor;
a memory that stores code executable by the processor to:
detect, by use of the processor, an input technique used to produce a textual message; and
transmit information corresponding to the input technique together with the textual message to provide a reader of the textual message the information corresponding to the input technique used to produce the textual message.

2. The apparatus of claim 1, wherein the code executable by the processor detects the input technique used to produce the textual message by detecting that the input technique is one or more of a voice, a keyboard, and a touch screen.

3. The apparatus of claim 1, wherein the code executable by the processor stores the information corresponding to the input technique with the textual message by storing metadata comprising the information corresponding to the input technique.

4. The apparatus of claim 1, wherein the code executable by the processor transmits information corresponding to producing the textual message with the textual message.

5. The apparatus of claim 4, wherein the code executable by the processor transmits the information corresponding to producing the textual message with the textual message by transmitting an indication indicating one or more of that the textual message was produced without proofreading the textual message, without reading the textual message, while walking, while driving, without editing the textual message, while multitasking, and with a word confidence selection.

6. A method comprising:
detecting, by use of a processor, a medium used to produce a textual message; and
transmitting information corresponding to the input technique together with the textual message to provide a reader of the textual message the information corresponding to the input technique used to produce the textual message.

7. The method of claim 6, wherein detecting the input technique used to produce the textual message comprises detecting that the input technique is one or more of a voice, a keyboard, and a touch screen.

8. The method of claim 6, further comprising storing the information corresponding to the input technique with the textual message, wherein storing the information comprises storing metadata comprising the information corresponding to the input technique.

9. The method of claim 6, further comprising storing the information corresponding to the input technique with the textual message, wherein storing the information comprises storing an indication indicating that the input technique is one or more of a voice, a keyboard, and a touch screen.

10. The method of claim 6, further comprising transmitting information corresponding to producing the textual message with the textual message.

11. The method of claim 10, wherein transmitting the information corresponding to producing the textual message with the textual message comprises transmitting an indication indicating one or more of that the textual message was produced without proofreading the textual message, without reading the textual message, while walking, while driving, without editing the textual message, while multitasking, and with a word confidence selection.

12. The method of claim 11, further comprising transmitting word confidence choices with the indication indicating that the textual message was produced with the word confidence selection.

13. The method of claim 11, further comprising detecting whether the textual message is read before the textual message is transmitted, and transmitting the indication indicating that the textual message was produced without reading the textual message in response to detecting that the textual message is not read before the textual message is transmitted.

14. The method of claim 13, wherein detecting whether the textual message is read before the textual message is transmitted comprises using eye tracking to detect whether the textual message is read.

15. A program product comprising a computer readable storage medium that stores code executable by a processor, the executable code comprising code to perform:
detecting, by use of the processor, a medium used to produce a textual message; and
transmitting information corresponding to the input technique together with the textual message to provide a reader of the textual message the information corresponding to the input technique used to produce the textual message.

16. The program product of claim 15, wherein the executable code further comprises code to perform detecting that the input technique is one or more of a voice, a keyboard, and a touch screen.

17. The program product of claim 15, wherein the executable code further comprises code to perform storing metadata comprising the information corresponding to the input technique.

18. The program product of claim 15, wherein the executable code further comprises code to perform transmitting an indication indicating that the input technique is one or more of a voice, a keyboard, and a touch screen.

19. The program product of claim 15, wherein the executable code further comprises code to perform transmitting an indication indicating one or more of that the textual message was produced without proofreading the textual message, without reading the textual message, while walking, while driving, without editing the textual message, while multitasking, and with a word confidence selection.

20. The program product of claim 19, wherein the executable code further comprises code to perform transmitting word confidence choices with the indication indicating that the textual message was produced with the word confidence selection.
